(19) United States
(12) Patent Application Publication
(10) Pub. No.: US 2006/0007220 A1
(43) Pub. Date: Jan. 12, 2006

(54) Light emitting device with adaptive intensity control

(76) Inventor: Frederick A. Perner, Santa Barbara, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/861,035

(22) Filed: Jun. 4, 2004

(51) Int. Cl. G09G 5/00

(52) U.S. Cl. 345/207; 345/82; 345/690

(57) ABSTRACT

A light emitting device with adaptive intensity control. In a particular embodiment, there is an active display pixel providing a light. At least a portion of the provided light is incident upon a photodetector optically coupled to the display pixel, the photodetector providing an electrical feedback signal in response to the light. A feedback controlled intensity controller electrically coupled to the photodetector and an electrical switch coupled to the active display pixel are also provided. The feedback controlled intensity controller further receives an electrical reference signal. The feedback controlled intensity controller opens and closes the switch depending upon the relationship of the feedback signal to the reference signal.

### FIELD OF THE INVENTION

The present invention relates generally to displays, and in particular to light emitting devices with adaptive intensity control.

### BACKGROUND

Socially and professionally, most people rely upon video displays in one form or another for at least a portion of their work and/or recreation. Cathode ray tubes (CRTs) have largely given way to displays composed of liquid crystal devices (LCDs) or light-emitting diodes (LEDs), as either can provide a visual image without the traditional bulk and weight associated with CRTs.

More specifically, as there is typically no tube, an LCD or LED display may be fabricated to be quite thin and light, providing for more portable laptop computers, video displays in vehicles and airplanes, and information displays to be mounted or set in eye catching locations.

A typical CRT display also requires far more power to operate than does a comparably sized LED display. For example a 14″ CRT display may require 110 watts of power whereas a 14″ LED display may require 30˜40 watts or less. Such difference in power consumption is extremely important in the field of portable devices that must operate off of a battery. In addition, such power conservation and low profile aspects are raising demand for in-home and in-office products where the savings in energy may total several hundred dollars per year.

A CRT operates by a scanning electron beam exciting phosphorous-based materials on the back side of the screen, wherein the intensity of each pixel is commonly tied to the intensity of the electron beam. With an LED display, each pixel is an individual light emitting device capable of generating its own light. With an LCD display, each pixel is a transient light emitting device, individually adjusted to permit light to shine through the pixel. For either device, the individual nature of each LED or LCD within the display introduces the possibility that each pixel may not provide the same quantity of light. One pixel may be brighter or darker than another, a difference that may be quite apparent to the viewer.

The human eye is able to perceive subtle differences in light intensity. This poses a challenge to display manufacturers. If the pixels in a display vary greatly in their light emitting ability, the display will be unacceptable to users. Generally, the light intensity of the display is controlled globally—all pixels are turned up or down to collectively brighten or dim the display.

With respect to an LED, the effective light output—the brightness—may be controlled by either of two methods: length of time on, and intensity when on. For example, LED #1 may operate at 100%, providing a light output of X, when the LED #1 is turned on for 5 nano-seconds. LED #2 may operate at 50%, providing a light output of X, when LED #2 is turned on for 10 nano-second. Cycling at a very fast rate, a user will likely be unaware that the two LED's are operating so differently. However, if both LED #1 and #2 are side by side in a display and the control logic of the display globally addresses all pixels with the same commands for when to turn on and off, the difference will likely be quite apparent.

To avoid such discrepancies in performance, great care is generally applied in the fabrication of LED and LCD displays in an attempt to insure that the pixels are as uniform and consistently alike as is possible. Frequently, especially with large displays, quality control measures discard a high percentage of displays before they are fully assembled. As such, displays are generally more expensive than they otherwise might be, as the manufacturers must recoup the costs for resources, time and precise tooling for the acceptable displays as well as the unacceptable displays.

Time, temperature and physical environmental conditions may adversely affect some pixels within a display while not affecting others. When and if such an event occurs, the user will more than likely find that the display is unacceptable as the intensity of the pixels is no longer uniform. Even where the pixels in the display age uniformly, a user may find that he or she must increase the contrast again and again in order to view the display. Eventually, even with the contrast fully increased, the display may appear too dark to be of relevant use.

Hence, there is a need for a light emitting device with adaptive intensity control that overcomes one or more of the drawbacks identified above.

### SUMMARY

The present disclosure advances the art and overcomes problems articulated above by providing a light emitting device with adaptive intensity control.

In particular and by way of example only, according to an embodiment of the present invention, this invention provides a light emitting device with adaptive intensity control, including: an active display pixel providing a light; a photodetector optically coupled to the display pixel, the photodetector providing an electrical feedback signal in response to the light; a feedback controlled intensity controller electrically coupled to the photodetector and an electrical switch coupled to the active display pixel, the feedback controlled intensity controller further receiving an electrical reference signal.

In an alternative embodiment, this invention provides a light emitting display with adaptive intensity control, including: a plurality of adaptive display pixels, each including: an active display pixel providing a light; a photodetector paired with and optically coupled to the active display pixel, the photodetector providing an electrical feedback signal in response to the light; a feedback controlled intensity controller electrically coupled to the photodetector and a switch coupled to the active display pixel, the feedback controlled intensity controller further receiving an electrical reference signal.

### BRIEF DESCRIPTION OF THE DRAWINGS

FIG. 1 is a block diagram of a light emitting device with adaptive intensity control according to one embodiment;

FIG. 2 is a conceptual electrical diagram of a light emitting device with adaptive intensity control according to an embodiment;

FIG. 3 is a conceptual electrical diagram of a light emitting device with adaptive intensity control according to yet another embodiment;

FIG. 4 is a partial side view of an embodiment of a light emitting device with adaptive intensity control;

FIG. 5 is a block diagram of a light emitting device with adaptive intensity control according to an alternative embodiment;

FIG. 6 is a chart illustrating the operation of the embodiment in FIG. 2; and

FIG. 7 is a chart illustrating the operation of the embodiment in FIG. 3.

### DETAILED DESCRIPTION

Before proceeding with the detailed description, it is to be appreciated that the present teaching is by way of example, not limitation. The concepts described herein are not limited to use or application with a specific type of light emitting device. Thus, although the instrumentalities described herein are for the convenience of explanation, shown and described with respect to exemplary embodiments, it will be appreciated that the principals herein may be equally applied in other types of light emitting devices.

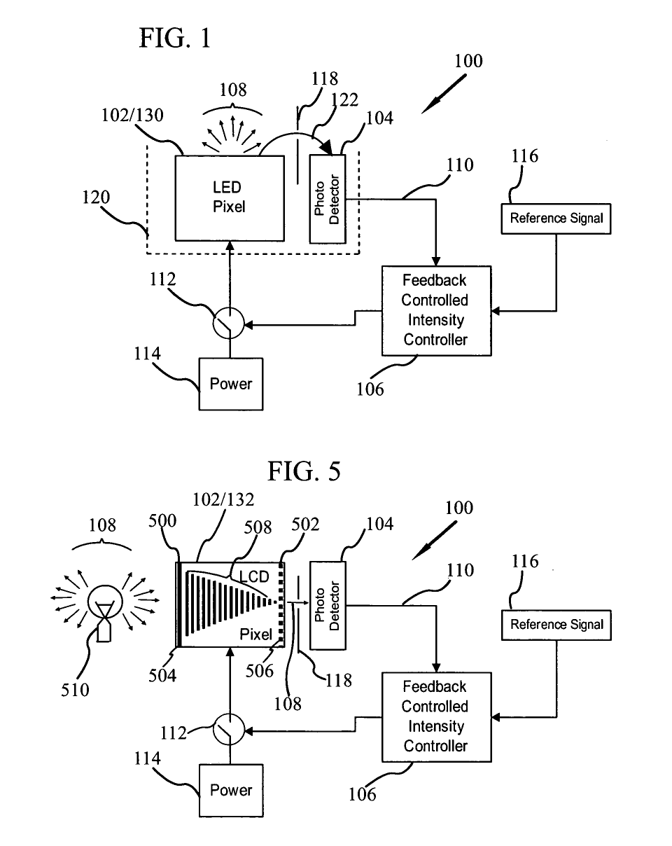

Referring now to the drawings, and more specifically to FIG. 1 and FIG. 5 there is shown a portion of a block diagram for a light emitting device with adaptive intensity control (LEDAIC) 100, according to one embodiment. More specifically, LEDAIC 100 includes an active display pixel 102, a photodetector 104 and a feedback controlled intensity controller 106.

The active display pixel 102 provides light 108, represented as arrows in FIGS. 1 and 5. More specifically, active display pixel 102 may either be a light generating pixel such as a light emitting diode 130, shown in FIG. 1, or a light permitting pixel such as a liquid crystal diode 132, shown in FIG. 5.

With respect to FIG. 1, photodetector 104 is optically coupled to active display pixel 102, as indicated by large arrow 122 extending from active display pixel 102 to photodetector 104. In other words, photodetector 104 receives light 108 directly from active display pixel 102. In at least one embodiment photodetector 104 may be physically coupled to active display pixel 102. The photodetector 104 provides an electrical feedback signal 110 in the form of a voltage feedback in response to the received light 108.

The feedback controlled intensity controller 106 is electrically coupled to photodetector 104 and to an electrical switch 112. The electrical switch 112 is coupled to active display pixel 102 and electrically connects active display pixel 102 to a power source 114. A reference electrical signal 116, such as a reference voltage, is also provided to feedback controlled intensity controller 106. This reference electrical signal 116 is used to set the intensity of LEDAIC 100. In at least one embodiment, this reference electrical signal 116 is pre-defined. Under appropriate circumstance, this reference electrical signal 116 may be user adjustable.

In at least one embodiment, a light restricting device 118, such as an aperture, may be placed between active display pixel 102 and photodetector 104. Employing a light restricting device 118 may be desired in certain embodiments wherein it is desirable to have photodetector 104 exposed to less than the full intensity of light 108 provided by active display pixel 102.

To further assist with the direct control of intensity of the active display pixel 102, photodetector 104 is shielded from external light, i.e., light not generated by active display pixel 102, or provided by active display pixel 102. Such shielding may be provided by design and placement of the photodetector 104 with respect to the active display pixel 102, and/or by providing a physical structure that serves as a external light shield, such as shielding 120, shown in FIG. 1.

Shielding 120 serves to shield components from external light, and is represented as a dotted line in FIG. 1. As an active display pixel 102 may be substantially larger than photodetector 104 and feedback controlled intensity controller 106, shielding 120 may shield all relevant components or simply the pixel 102 and photodetector 104.

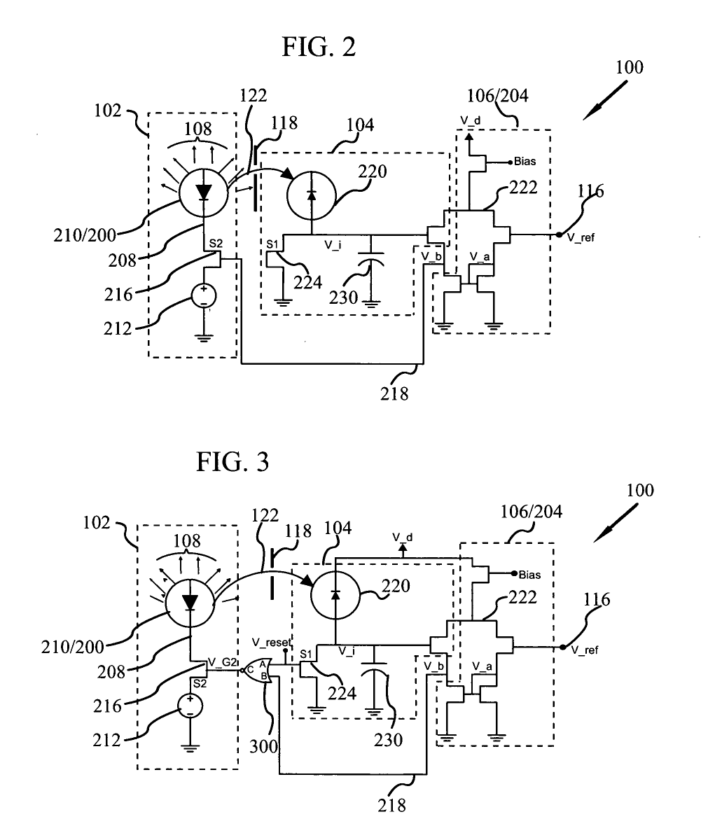

FIG. 2 provides a conceptual electrical schematic of LEDAIC 100 including an active display pixel 102, a photodetector 104 and a feedback controlled intensity controller 106. To assist with this discussion, specific elements of this schematic have been set apart by dotted boxes, specifically a display pixel 200, a photodetector 104, and a feedback controlled control circuit 204. V_d is the VDD supply source for photodetector 104 and the feedback controlled control circuit 204

In this conceptual electrical schematic, active display pixel 102 is depicted as light emitting diode (LED) 210. The LED 210 is electrically coupled to power source 212 by conductive line 208 running through switch S2, illustrated as switch 216. When switch S2 216 is closed, power is provided to LED 210 and light 108, shown as arrows in FIG. 2, is provided.

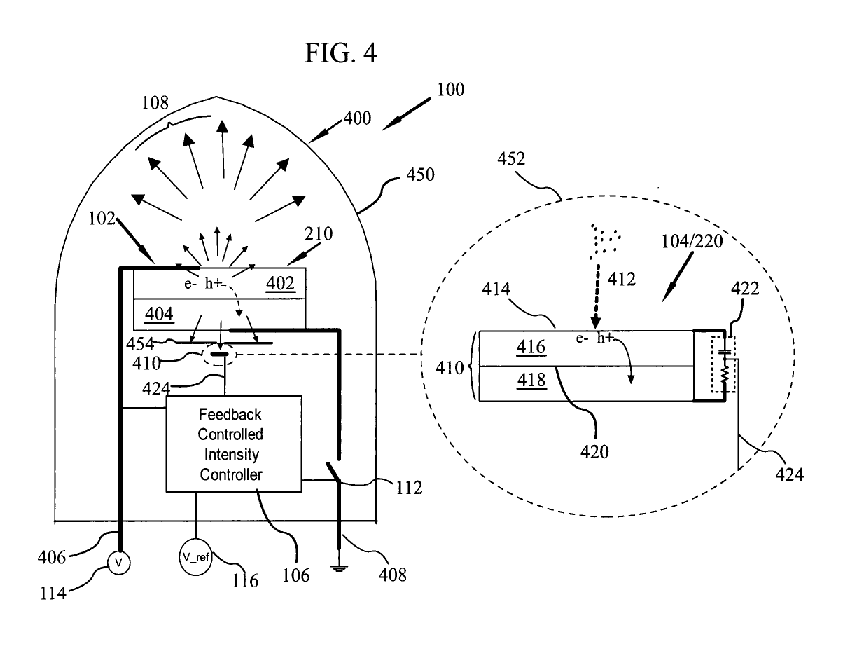

In at least one embodiment, photodetector 104 is a CMOS active pixel sensor 220, also referred to as an APS. A typical CMOS active pixel sensor 220 is understood and appreciated to consist of a photosensitive diode, biased by a power supply, a capacitor functioning as an integrator, a transistor switch to discharge and set the initial conditions on the capacitor, and a transistor that acts as a source follower. As further described below and illustrated in FIG. 4, when light 108 is incident upon active pixel sensor 220, active pixel sensor 220 will provide an electrical output, such as for example V_i.

The feedback controlled intensity controller 106 is composed of several components, namely, in at least one embodiment, an integration capacitor 230 electrically coupled to both CMOS active pixel sensor 220 and a comparator 222. A reference signal, such as V_ref, is provided to comparator 222. This reference signal V_ref is used to externally set the intensity of LEDAIC 100. A reset switch S1, illustrated as switch 224, is also provided to discharge the integration capacitor 230 and reset control circuit 204. A Bias signal is also provided as an external control signal that is used to set the sensitivity of comparator 222.

The advantageous autonomous control of LEDAIC 100 is achieved as follows. Light 108 emitted by LED 210 is received by CMOS active pixel sensor 220 and converted from a light sensitive photo current to a voltage, V_i by integrating the photo current over a display time interval. This V_i is then compared to a reference voltage V_ref, by comparator 222. V_ref is an analog signal provided by an external control circuit (not shown) to control light 108 emitted from display pixel 102 to a predetermined amount. When the amount of emitted light 108 generates a V_i equal to V_ref, comparator 222 turns off LED 210 by opening switch S2 216. The opening of switch S2 216 is accomplished by sending signal V_b through conductive line 218.

Stated another way, the feedback controlled intensity controller 106 is operable to open electrical switch S2 216 when electrical feedback signal V_i is equal to or greater than the electrical reference signal, V_ref. The feedback controlled intensity controller 106 is further operable to close electrical switch S2 216 when the electrical feedback signal V_i is less than the electrical reference signal V_ref.

Moreover, the rate at which integration capacitor 230 is charged is fully dependent upon the intensity of light 108 provided by display pixel 200 to photodetector 104. In other words, LEDAIC 100 is converting the intensity of light 108 into a duration of time. The amount of light 108 perceived by a user observing a LEDAIC 100 is dependent upon both the intensity of light 108 and the duration of the light 108. A high current through LED 210 for a short duration or a low current through LED 210 for a long duration can yield the same user-perceived intensity of light 108.

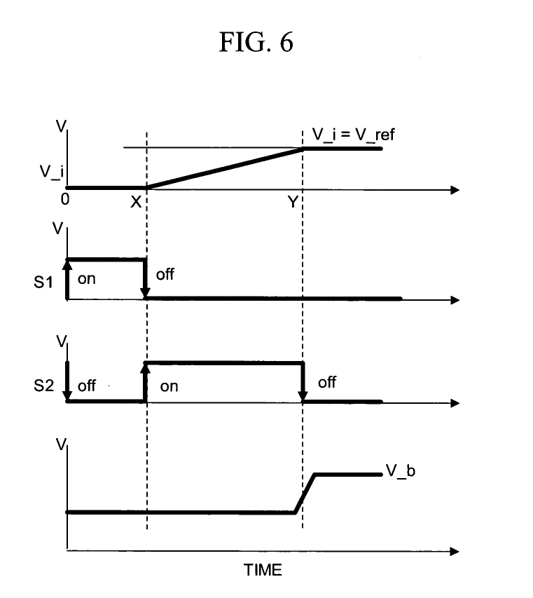

FIG. 6 provides a set of graphs illustrating the lifecycle of feedback signal V_i as it is related to switches S1 224 and S2 216 as well as signals V_b shown in FIG. 2. As shown, at time value 0, V_i is substantially zero. Switch S1 224 is activated to reset the LEDAIC 100 and correspondingly switch S2 216 is turned off. At time value X, Switch S1 224 is turned off and switch S2 216 is turned on. As a result, power is supplied to LED 210, which in turn provides light 108 that is incident upon photodetector 104 (such as active pixel sensor 220). As a result of this incident light, the voltage on integration capacitor 230 is ramped up to V_i. When V_i =V_ref, comparator 222 opens switch S2 216 with a pulse. More specifically, V_a is an internal signal of comparator 222. The lower transistors of the comparator 222 form a current mirror load circuit which develops a large voltage swing on node V_b depending on the relative value of the gate voltages V_i and V_ref on the source followers connected to the current mirror load circuit.

Typically, in operation, the light emissive device such as LED 210, is cycled repeatedly, and/or connected to a refresh circuit. In addition, the period of the cycle is generally so fast that LED 210 is perceived as a substantially steady light source and not a blinking one.

FIG. 3 illustrates an alternative embodiment for LEDAIC 100 further providing a logical gate, such as for example, a logic NOR gate 300. The logic NOR gate 300 is coupled to switch S2 216. The logic NOR gate 300 is controlled by feedback signal V_b from comparator 222 on NOR terminal B, and by a control signal V_reset. V_reset is also provided and coupled to switch S1 224 and logic NOR gate 300. The logic NOR gate 300 is provided to further improve both performance and design complexity such as, for example when a plurality of LEDAIC 100 devices are used in a large display.

The control signal for switch S2 is adaptively generated from both an external signal that initiates the display cycle (V_reset), and an internal feedback signal (V_b). Specifically, design efficiency is improved by integrating a low transistor count, logic NOR gate 300 into LEDAIC 100 and generating a control signal for display pixel 102 from an external control signal V_reset, and an internal feedback signal V_b.

This method of control advantageously simplifies and improves the adaptive intensity control of display pixel 102 individually, and the plurality of LEDAIC 100 devices in a display. This improvement is achieved by turning on all display pixels 102 in a selected group (the entire display or a specific sub-group) and causing individual LEDAIC 100 devices to turn off when an amount of emitted light is equivelant to a threshold specified by an analog voltage (V_ref) externally supplied to each LEDAIC 100.

The operational characteristics of LEDAIC 100 (specifically the condition of switch S2 as open or closed), as the signals provided to logic NOR gate 300 terminals A and B determine the signal provided to NOR terminal C controlling switch S2, are shown in the following table.

| A | B | C |
|---|---|---|
| 0 | 0 | 1 |
| 0 | 1 | 0 |
| 1 | 0 | 0 |
| 1 | 1 | 0 |

The logic NOR gate 300 is an effective control element that combines the integrator reset switch S1 with the control signal V_reset to turn on display pixel 102 and initiate the intensity control circuit 204. When V_reset is high, S1 is on and the voltage on capacitor 230 is held at ground. The output of logic NOR gate 300 is held low so that switch S2 is off and display pixel 102 is off. The output of comparator 222, specifically V_b, is also held low (V_i<V_ref). When V_reset is switched low, switch S1 is opened and the output of logic NOR gate 300 will go high, and turn on switch S2, thus causing display pixel 102 to emit or pass light 108. This relationship for this condition is V_i<V_ref causing V_b to be made low.

Light 108 from display pixel 102 passing through light restricting device 118 causes a photo current to ramp up the voltage in the integration capacitor for a display time interval until V_i>V_ref. When V_i>V_ref, comparator 222 switches so that V_b goes from a low potential to a potential greater than the switch threshold of logic NOR gate 300. This switch causes the output of logic NOR gate 300 to go from high to low. When the output of logic NOR gate 300 switches from high to low, switch S2 turns off and display pixel 102 is turned off completing the display cycle.

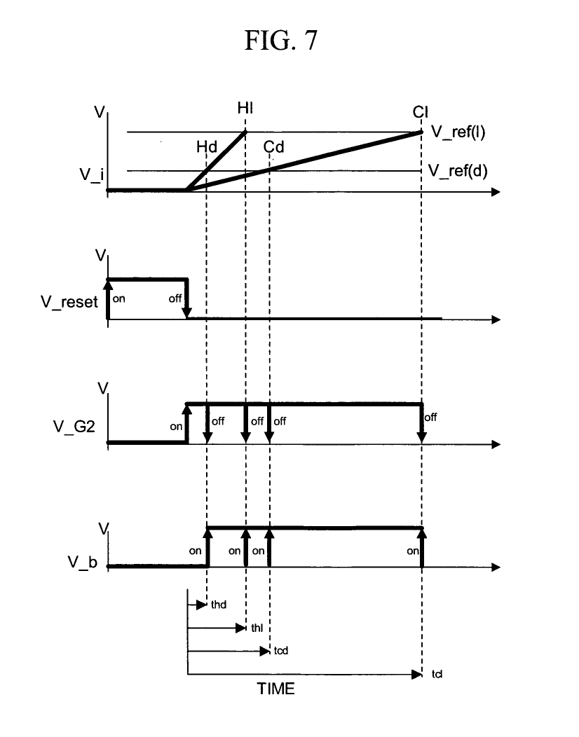

Similar to FIG. 6, FIG. 7 provides a set of graphs illustrating the lifecycle of feedback signal V_i as it is related to the signals V_reset, V_G2 and V_b shown in FIG. 3. Specifically, FIG. 7 illustrates V_ref as it may be applied to a dark pixel {V_ref(d)} and a lighter pixel {V_ref(l)}. As the chart demonstrates, less charge is needed from the photo diode for a darker pixel than for a lighter pixel.

For a given value of a gray scale, or brightness value for a color, it will take the low intensity LEDAIC 100, i.e., a “Cold” pixel, a longer time for integration capacitor 230 to develop a charge equal to the supplied V_ref than a high intensity LEDAIC 100, i.e., a “Hot” pixel. With respect to FIG. 7, Hl=Hot(light pixel), Hd =Hot(dark pixel), Cl=Cold(light pixel) and Cd=Cold(dark pixel). Specifically, FIG. 7 demonstrates how a Hot and Cold pixel will control switch S2 216 gate potential V_G2. The illustrated time sequences are as follows:
thd=active display time for a Hot pixel and a darker display
thl=active display time for a Hot pixel and a light display
tcd=active display time for a Cold pixel and a darker display
tcl=active display time for a Cold pixel and a light display

In a typical visual display, thousands of pixels are provided, working in concert to present visual information to the user. Typically, the resolution of the display is provided with direct reference to the number of pixels provided, for example, common resolutions include 640×480, 800×600, 1024×768 and 1600×1200. A higher resolution display can usually operate in a backward compatible mode to display lower resolution images.

With a 14″ display screen, a 1600×1200 pixel resolution yields approximately 20,000 pixels per square inch. Though this number may appear large, contemporary submicron-technology manufacturing processes permit the fabrication of diode structures, such as photosensitive diodes, measured on a nano-meter scale. More specifically, whereas a single horizontal inch may generally include approximately 142 display pixels, a single horizontal inch may easily include several thousand photosensitive diodes.

FIG. 4 conceptually illustrates an actual LEDAIC 100 as an autonomous device. A plurality of LEDAICs 100 are preferably used to provide a full light emitting display with adaptive intensity control. In such a display, as described above, each photodetector 104 is optically coupled to an active display pixel 102, the two forming a matched pair.

With respect to LEDAIC 100 illustrated in FIG. 4, stated simply, LED 210 is a simplistic type of semiconductor device. Generally speaking, a diode is created by layering two different conductive materials (such as Silicon, Aluminum, Gallium or other appropriate material) together in a specific way. In pure form, the atoms of these materials will bond perfectly, leaving no free electrons to conduct current. By doping, the addition of impurities adds additional atoms that change the balance, either adding free electrons or creating electron holes—locations where electrons can go. Doping to add electrons produces materials that are known as N-type. Doping to add holes produces materials that are P-type.

The LEDAIC 100 shown in FIG. 4 includes a light emitting diode (LED) 400 having a layer of N-type material 402 coupled to a section of P-type material 404, with electrodes 406, 408 attached to each section respectively. When LED 400 is at rest, with no applied charge, electrons and holes migrate and balance along junction 420 between the first and second layers 416, 418, forming a depletion zone. By applying a positive current to the P-type section (P-type material 404) and a negative charge to the N-type section (N-type material 402), a charge will move across the diode.

The functional properties of a semiconductor, such as an LED 400, result in part from providing electrons in different energy states separated by bands, or gaps, of no energy states. The highest occupied band is a valence band and the lowest unoccupied band is a conduction band, with a gap existing in between. As used, the terms “highest” and “lowest” refer to energy levels and not physical vertical separation. Visible light emitting diodes are made of materials providing wide gaps between the valance band and the conduction band. As an electron moves from a high band to a lower band, it releases energy in the form of photons. The size of the gap determines the frequency of the photon, and consequently, the color of the light produced.

As is conceptually illustrated, light emitting diode 400 is substantially larger than photodetector 104 and feedback controlled intensity controller 106. A simplified illustration of photodetector 104 is shown as an enlargement 452, bounded by a dotted line. As such, light emitting diode 400, photodetector 104 and feedback controlled intensity controller 106 are all housed within a protective housing 450 of the LEDAIC 100. Conventional semiconductor fabrication techniques permit the fabrication of light emitting diode 400, photodetector 104 and potentially feedback controlled intensity controller 106 collectively and upon the same substrate material to be later placed within protective housing 450.

As stated above, photodetector 104, such as CMOS active pixel sensor 220, includes a photosensitive diode 410. More specifically, photosensitive diode 410 is a diode that provides electron hole pairs (e− h+) when light photons 412 are incident upon surface 414 of diode 410. The photodetector 104 may be disposed below light emitting diode 400, as shown, or adjacent to light emitting diode 400. In addition, a light restricting device 454, such as an aperture, may be disposed between photosensitive diode 410 and light emitting diode 400 to restrict the amount of light 108 incident upon photosensitive diode 410. Moreover, to insure proper feedback control over light emitting diode 400, photodetector 104 is positioned so as to receive light 108 only from its paired active light emitting diode 400.

Most commonly, photosensitive diode 410 provides a built-in field for separating charged carriers, such as a PN junction, PIN junction, Schottky barrier device or other type of “electronic valve” device as known in the art. Internally, at least two layers are provided. A first layer 416 with a first electrical connectivity, such as a P-type layer, and a second layer 418 with a second electrical connectivity, such as a layer of N-type material 402, physically coupled to the first layer 416. The electrical connectivity of each layer 402 and 416 is determined by factors such as differences in carrier concentrations, carrier types, and or band structures. The coupled area provides an interface, also know as a junction 420.

Light 108 from LED 210 is incident upon outer surface 414 of active pixel sensor 220. Light photons 412 excite electron hole pairs, otherwise known as charged carriers. Some fraction of the generated carriers of one sign (either electrons or holes) will be swept across junction 420.

Depending upon the configuration of photodetector 104, the movement of the carriers will result in either an electric potential, such as a voltage potential, or an active current, either of which is detected by a simple control circuit 422 and provided as electrical feedback output to the feedback controlled intensity controller 106 via feedback conductor 424. In at least one embodiment, CMOS active pixel sensor 220 provides a voltage potential in response to the incidence of light 108.

With respect to FIG. 4, it is appreciated that a plurality of LEDAICs 100 operating collectively can and will provide an advantageous light emitting display. As described above, each LEDAIC 100 is capable of autonomous operation to provide a consistent and pre-determined intensity of light output based on a provided reference signal, V_ref. As such, the operational characteristics from one LEDAIC 100 to another may vary.

More specifically, the fabrication tolerances may be somewhat relaxed as each LEDAIC 100 within the display will advantageously self adjust. In addition, the longevity of the display incorporating a plurality of LEDAICs 100 will likely be improved as each LEDAIC 100 can and will self adjust due to age and environmental factors, which may or may not affect the display in its entirety.

In addition, as may be appreciated in FIG. 4, in at least one embodiment, the reference signal, V_ref is provided to the feedback controlled intensity controller 106 from outside the physical structure of the LEDAIC 100. As such, the same V_ref may be provided to the plurality of LEDAICs 100, comprising a display. Providing the plurality of LEDAICs 100 with the same V_ref advantageously insures that all of the LEDAICs 100 are self comparing to the same reference threshold, thus further insuring the uniform intensity of light throughout the display. In at least one embodiment, the value of V_ref is predetermined. Under appropriate circumstances, such as where a user is permitted to adjust the intensity of the display, the value of V_ref may be user adjustable.

The above embodiments have involved the use of an active display pixel such as an LED 210, a device which actively generates light. Substantially the same methodology and structure may be employed where LEDAIC 100 utilizes a liquid crystal display (LCD), a device actively adjusted to pass light.

Generally speaking, and with reference to FIG. 5, to create an LCD, a first and a second polarized glass plate 500, 502 are provided, each having microscopic groves in the surface opposite from but in line with a polarizing film. The first and second polarized glass plates 500, 502 are parallel to one another with the respective polarizing film of each transverse to the other. For illustrative purposes, the polarizing film and groves of first glass plate 500 run parallel to the page, such that they are represented as solid line 504. In contrast, the polarizing film and groves of second glass plate 502 are perpendicular to the page, such that they are represented as parallel cross sections 506.

Nematic liquid crystals 508 are then added between the first and second glass plates 500, 502. The groves will cause the layer of molecules of liquid crystals 508 that are in contact with the grooved glass to align with the groves. As the groves of one glass are transverse to the groves of the other glass, the Nematic liquid crystal 508 will twist. In the 2-D illustration of FIG. 5 this is represented as nematic liquid crystal 508 appearing to diminish in size as it progresses from glass plate 500 to glass plate 502.

As light 108 provided by an external light source 510 strikes first glass plate 500, it is polarized. The molecules in each layer of nematic liquid crystal 508 then guide the light 108 from layer to layer within nematic liquid crystal 508, and in so doing, twist the light 108 to align with the groves and the polarized filter of the second glass plate 502.

If an electric charge is applied to nematic liquid crystal 508, the molecules will untwist. As nematic liquid crystal 508 straightens out, the angle of the light 108 passing through from first glass plate 500 to second glass plate 502 will also change, and the cross polarization orientation will block the passage of light 108. By varying the degree of untwisting, the LCD utilizing nematic liquid crystal 508 can control how much of light 108 passes through, thus providing a gray scale.

As with the description provided above for active display pixel 102 and LED 210, feedback signal 110 provided by photodetector 104 is compared to a reference electrical signal 116 provided by feedback controlled intensity controller 106. Based on the evaluation of this comparison, feedback controlled intensity controller 106 opens or closes electrical switch 112, thus causing an electric field to be applied to, or removed from, the nematic liquid crystal 508.

As in the above discussion, a light restricting device 118 may be provided between photodetector 104 and LCD pixel 132. Moreover, it is understood and appreciated that photodetector 104 is so positioned and/or shielded that it does not receive external light, i.e., light that does not come from or pass through active display pixel 102 or light emitting diode 130.

Changes may be made in the above methods, systems and structures without departing from the scope hereof. It should thus be noted that the matter contained in the above description and/or shown in the accompanying drawings should be interpreted as illustrative and not in a limiting sense. The following claims are intended to cover all generic and specific features described herein, as well as all statements of the scope of the present method, system and structure, which, as a matter of language, might be said to fall therebetween.

I claim:

1. A light emitting device with adaptive intensity control, comprising:
an active display pixel providing a light;
a photodetector optically coupled to the display pixel, the photodetector providing an electrical feedback signal in response to the light;
a feedback controlled intensity controller electrically coupled to the photodetector and an electrical switch coupled to the active display pixel, feedback controlled intensity controller further receiving an electrical reference signal.

2. The light emitting device with adaptive intensity control of claim 1, wherein the feedback controlled intensity controller is operable to open the electrical switch when the electrical feedback signal is equal to or greater than the electrical reference signal, and to close the electrical switch when the electrical feedback signal is less than the electrical reference signal.

3. The light emitting device with adaptive intensity control of claim 1, wherein the light emitting device with adaptive intensity control is an autonomous device.

4. The light emitting device with adaptive intensity control of claim 1, wherein the photodetector is shielded from external light.

5. The light emitting device with adaptive intensity control of claim 1, further including a light restricting device disposed between the active display pixel and the photodetector.

6. The light emitting device with adaptive intensity control of claim 6, wherein the light restricting device is an aperture.

7. The light emitting device with adaptive intensity control of claim 1, wherein the feedback controlled intensity controller further includes an integrator capacitor and an analog comparator.

8. The light emitting device with adaptive intensity control of claim 1, wherein the feedback controlled intensity controller further includes a logic NOR gate.

9. The light emitting device with adaptive intensity control of claim 1, further including a reset switch coupled to the active display pixel.

10. The light emitting device with adaptive intensity control of claim 1, wherein the photodetector is a CMOS active pixel sensor.

11. The light emitting device with adaptive intensity control of claim 1, wherein the electrical signals are voltages.

12. The light emitting device with adaptive intensity control of claim 1, wherein the electrical signals are currents.

13. The light emitting device with adaptive intensity control of claim 1, wherein the active display pixel is an LED.

14. The light emitting device with adaptive intensity control of claim 1, wherein the active display pixel is an LCD.

15. A light emitting display with adaptive intensity control, comprising:
a plurality of self controlled display pixels, each including:
an active display pixel providing a light;
a photodetector paired with and optically coupled to the active display pixel, the photodetector providing an electrical feedback signal in response to the light;
a feedback controlled intensity controller electrically coupled to the photodetector and a switch coupled to the active display pixel, the feedback controlled intensity controller further receiving an electrical reference signal.

16. The light emitting display with adaptive intensity control of claim 15, wherein each feedback controlled intensity controller is operable to open the electrical switch when the electrical feedback signal is equal to or greater than the electrical reference signal, and to close the electrical switch when the electrical feedback signal is less than the electrical reference signal.

17. The light emitting display with adaptive intensity control of claim 15, wherein each self controlled display pixel operates autonomously.

18. The light emitting display with adaptive intensity control of claim 15, wherein the electrical reference signal is user adjustable.

19. The light emitting display with adaptive intensity control of claim 15, wherein the electrical reference signal is pre-defined.

20. The light emitting display with adaptive intensity control of claim 15, wherein the active display pixel is an LED.

21. The light emitting display with adaptive intensity control of claim 15, wherein the active display pixel is an LCD.

22. The light emitting display with adaptive intensity control of claim 15, wherein each photodetector receives light only from its paired active display pixel.

23. The light emitting display with adaptive intensity control of claim 15, further including a light restricting device disposed between the active display pixel and the photodetector.

24. The light emitting display with adaptive intensity control of claim 23, wherein the light restricting device is an aperture.

25. A light emitting device with adaptive intensity control, comprising:
an active display pixel;
an electrical switch coupled to the display pixel;
a logical gate coupled to the switch;
a photodetector optically coupled to the display pixel; the photodetector operable to provide an electrical feedback signal in response to optical input;
a feedback controlled intensity controller electrically coupled to the photodetector and the logical gate, the control circuit further receiving an electrical reference signal.

26. The light emitting device with adaptive intensity control of claim 25, wherein the feedback controlled intensity controller further includes:
a reset switch;
an integrator capacitor electrically coupled to the reset switch; and
a differential amplifier, the differential amplifier having an output electrically coupled to the logical gate.

27. The light emitting device with adaptive intensity control of claim 25, wherein the logical gate is an NOR gate.

28. The light emitting device with adaptive intensity control of claim 25, wherein the electrical feedback signal and the electrical reference signal are voltages.

29. The light emitting device with adaptive intensity control of claim 25, wherein the feedback controlled intensity controller is operable to open the electrical switch when the feedback electrical signal is equal to or greater than the reference electrical signal, and to close the electrical switch when the feedback electrical signal is less than the reference electrical signal.

30. The light emitting device with adaptive intensity control of claim 25, wherein the optical detector is shielded from external light.

31. The light emitting device with adaptive intensity control of claim 25, further including a light restricting device disposed between the active display pixel and the photodetector.

32. The light emitting device with adaptive intensity control of claim 31, wherein the light restricting device is an aperture.
